(19) United States
(12) Patent Application Publication
(10) Pub. No.: US 2024/0093026 A1
(43) Pub. Date: Mar. 21, 2024

(54) COMPOSITION AND METHOD FOR PRODUCTION OF A HIGHLY FLEXIBLE PHA SHEET

(71) Applicant: Newlight Technologies, Inc., Huntington Beach, CA (US)

(72) Inventors: Joseph Kim, Huntington Beach, CA (US); Scott W. Wollack, Costa Mesa, CA (US)

(21) Appl. No.: 18/275,794

(22) PCT Filed: Sep. 21, 2021
(86) PCT No.: PCT/US2021/051263

§ 371 Date: Aug. 3, 2023

Related U.S. Application Data
(60) Provisional application No. 63/147,697, filed on Feb. 9, 2021.

(51) Int. Cl. C08L 67/04; B29C 48/00; B29C 48/25; C08J 5/18

(52) U.S. Cl. CPC C08L 67/04; B29C 48/0018; B29C 48/022; B29C 48/267; C08J 5/18; B29C 2948/92152; B29C 2948/92561; B29C 2948/92704

(57) ABSTRACT

The present specification generally relates an aliphatic polyester material and a process for converting said aliphatic polyester material into a textile that is preferable for use as an artificial leather substrate. The present invention discloses: (i) a novel aliphatic polyester composition comprising a polyhydroxyalkanoate (referred to herein as PHA), an ethylene-vinyl acetate copolymer resin (referred to herein as EVA) or similarly functional such material, and an ester of citrate acid plasticizer or similarly functional such material; and (ii) an inventive process for converting the novel aliphatic polyester composition into a textile by (a) melt extruding the aliphatic polyester material into an aliphatic polyester sheet; (b) heating said sheet; and (c) monoaxially or biaxially orienting said sheet in the machine direction followed by orientation in the transverse direction; and/or heating the monoaxially or biaxially oriented sheet at a temperature above the Tg of both the polyhydroxyalkanoate and ethylene-vinyl acetate resin components but below the melting point of the polyhydroxyalkanoat component.

### PRIORITY AND INCORPORATION BY REFERENCE

This application claims priority to, and incorporates by reference, U.S. Provisional Application No. 63/147,697, filed Feb. 9, 2021, entitled “COMPOSITION AND METHOD FOR PRODUCTION OF A HIGHLY FLEXIBLE PHA SHEET.”

### BACKGROUND OF THE INVENTION

### 1. Field of the Invention

The present specification generally relates an aliphatic polyester material and a process for converting said aliphatic polyester material into a textile that is preferable for use as an artificial leather substrate. The present invention discloses: (i) a novel aliphatic polyester composition comprising a polyhydroxyalkanoate (referred to herein as PHA), an ethylene-vinyl acetate copolymer resin (referred to herein as EVA), and an ester of citrate acid plasticizer; and (ii) an inventive process for converting the novel aliphatic polyester composition into a textile by (a) melt extruding the aliphatic polyester material into an aliphatic polyester sheet; (b) heating said sheet; (c) biaxially orienting said sheet in the machine direction followed by orientation in the transverse direction; and (d) heating the biaxially oriented sheet under tension at a temperature above the Tg of both the polyhydroxyalkanoate and ethylene-vinyl acetate resin components but below the melting point of the polyhydroxyalkanoate component. The resultant textile obtains a suppleness that is similar to that of leather and displays a Young's modulus (E) (measured in accordance with ISO 527) in the range of between 1 and 300 MPa, preferably in the range of between 20 and 100 MPa, in particular less than 70 MPa and flexural fatigue (measured in accordance with ISO 5402) reaching greater than 100,000 cycles. The textile may be utilized as upholstery fabric in furniture or in automobiles, apparel, and the like. The particular textiles produced are also contemplated within this invention.

### 2. Description of the State of the Art

Leather is likely the most ancient fabric used by humans, and today leather comprises a multi-billion dollar global industry which is among the most polluting industries in the world. However, as the demand for leather goods continues to grow, so does the environmental and ethical criticisms of the leather industry, which is driving a keen interest in sustainable alternatives.

Without even accounting for the ethical risk around animal cruelty, if you choose to buy a bag, shoes, or another item made of leather, you are purchasing something that also poses serious environmental risks. The pollution of the leather industry is caused by two factors; the need to raise livestock and the process of leather manufacturing itself. The first, raising livestock, has been deemed as the most important factor in fueling climate change. The Food and Agriculture Organization estimates that approximately 3.8 billion cows and other bovine animals are used in leather production each year, around one animal for every two people on the planet. It has been estimated that animal agriculture is responsible for 18% of greenhouse gases; more than the combined exhaust of all transportation. Livestock consumes 80%-90% of water in the U.S. and occupies around 45% of earth's total land, leading the charge in desertification which totals around ⅓ of the planet today. Meanwhile, vast tracts of land are cleared worldwide to make room for livestock such as cattle, which are the main source of leather. According to Wageningen University and Research Centre, “agriculture is estimated to be the direct driver for around 80% of deforestation worldwide.” This means that animal habitats are destroyed and there are fewer wild places left on Earth.

The second factor, leather manufacturing and processing or tanning, leads to the formation of both solid waste and wastewater effluent containing toxic and hazardous chemicals. Tanning is the most toxic phase in leather processing, with 90% of production using chromium tanning. Hides are doused in drums of water, chromium salts and tanning liquor to stop them decomposing and to give a supple, color-fast leather. This produces a slush of chemicals and gases, including carcinogenic chromium (IV). This is so noxious that strict regulations governing it have forced the closure of tanneries in the US and Europe. In developing countries, such as Africa, India, Bangladesh, China and Latin America, which produce more than half the world's supply of raw leather, the untreated effluent, potentially laced with chromium, lead, arsenic and acids, often flows directly into local waterways. Recent estimates suggest that 300 kilograms of chemicals used for every 900 kilograms of animal hides tanned, while 17,000 liters of water are needed to produce just 1 kilogram of leather. These developing nations often have zero regulations concerning the disposal of these hazardous byproducts, or if they do, lack the controls necessary to ensure that toxic chemicals are being disposed of responsibly. But all too often the nearest waterways have become a dumping ground for polluters discharging the tanning process effluent which is toxic to aquatic life and poses severe risks to humans including respiratory problems, infections, infertility and birth defects.

Working in a tannery is extremely hazardous, especially in places where workplace protections are few or non-existent. In many places, workers, including children as young as 10 years old in some countries risk injury from heavy machinery as well as severe side-effects from exposure to these toxic chemicals due to the lack of protective equipment or clothing. Acute effects include irritation to the mouth, airways and eyes; skin reactions; digestive problems, kidney or liver damage; long-term cancer and reproductive problems.

Synthetic alternatives to leather have existed for decades and are similar in appearance and properties to animal leather. These textiles, sometimes referred to as vegan leather or ‘faux leather’, are fabrics often made from microfibers, polyurethane (PU), polyvinyl chloride (PVC) and other synthetic materials. While synthetic alternatives scores better than leather on the Higg Index with lower scores for global warming and pollution, disposal of PU and PVC pose its own environmental problems.

In recent years, biologically grown materials made using greenhouse gas have been actively developed as materials that can solve problems caused by the heavy burden of plastic waste on the global environment, such as harmful effects on the ecosystem, generation of harmful gas during combustion, and global warming due to a large amount of heat generated by combustion. Particularly, greenhouse gas emissions, such as methane or carbon dioxide, originally present in the air or that would have otherwise become part of the air can be used to produce materials. Therefore, combustion of greenhouse gas-derived materials does not increase the amount of carbon dioxide equivalents in the atmosphere. This is referred to as “carbon neutral”, and is regarded as important under The Kyoto Protocol that sets targets for reducing carbon dioxide emissions. Therefore, active use of greenhouse gas-derived materials is desired. More impressively is that methane is 84 times more potent than carbon dioxide in the first two decades after its release, causing it to be far more devastating to the climate because of how effectively it absorbs heat compared to carbon dioxide. Consequently, methane-derived materials are capable of reducing the carbon footprint of the product produced therefrom to less than neutral, so that there is a net effect of removing carbon dioxide equivalents from the atmosphere rather than adding to it.

Recently, from the viewpoint of chemical pollution, carbon neutrality and carbon negativity, aliphatic polyester-based resins have received attention as sustainable materials. Particularly, polyhydroxyalkanoate (hereinafter, sometimes referred to as PHA)-based resins have received attention. Among PHA-based resins, poly(3-hydroxybutyrate) homopolymer resins (hereinafter, sometimes referred to as P3HB), poly(3-hydroxybutyrate-co-3-hydroxyvalerate) copolymer resins (hereinafter, sometimes referred to as P3HB3HV), poly(3-hydroxybutyrate-co-3-hydroxyhexanoate) copolymer resins (hereinafter, sometimes referred to as P3HB3HH), poly(3-hydroxybutyrate-co-4-hydroxybutyrate) copolymer resins, polylactic acid, etc. have received attention.

However, it is known that PHA-based products, and PHB-based materials in particular, are hard materials whereas leathers are known to be a very soft, drapey and supple material that can become softer and more supple with use. Generally, a plasticizer is added to impart flexibility to a hard resin. This, however, involves a problem that bleeding occurs due to the use of a large amount of plasticizer.

Thus a need exists for more sustainable solutions for producing PHA-based products with leather-like characteristics that can become softer and more supple with use from sustainable, carbon-negative materials destined for use in furniture, automotive, apparel, footwear and accessories, thereby creating an environmental benefit by either removing greenhouse gases from the atmosphere or otherwise diverting it from becoming part of the atmosphere.

### BRIEF SUMMARY OF THE INVENTION

The present invention addresses a need for producing high-grade replacement materials for leathers and suedes derived from sustainable, carbon negative materials destined for use in apparel, footwear and accessories, thereby creating an environmental benefit by removing greenhouse gases from the atmosphere.

The present invention further provides an aliphatic polyester material and a process for converting said aliphatic polyester material into a textile that is preferable for use as a leather substrate.

In general, the present invention describes an environmentally sustainable composition, an aliphatic polyester composition comprising polyhydroxyalkanoate (PHA), an ethylene-vinyl acetate copolymer resin (EVA), and a plasticizer.

The novel an aliphatic polyester composition comprises polyhydroxyalkanoate (PHA), an ethylene-vinyl acetate copolymer resin (EVA), and an ester of citrate acid plasticizer. Preferably, the composition of the present invention, which is carbon negative, comprises about 10% to about 90% by weight PHA, about 10% to about 90% by weight EVA and about 2% to about 25% by weight plasticizer.

Also provided herein are methods of fabricating a textile (a) producing an aliphatic polyester composition comprising a polyhydroxyalkanoate, an ethylene-vinyl acetate copolymer resin, and an ester of citrate acid plasticizer; (b) melt extruding the aliphatic polyester material into an aliphatic polyester sheet; (c) heating said sheet; (d) monoaxially or biaxially orienting said sheet including in the machine direction followed by orientation in the transverse direction; and (e) heating the monoaxially or biaxially oriented sheet at a temperature above the Tg of both the polyhydroxyalkanoate and ethylene-vinyl acetate resin components but below the melting point of the polyhydroxyalkanoate component.

The novel aliphatic polyester compositions of this invention can be fabricated into commercially useful textiles, such as, but not limited to film or sheets having a suppleness that is similar to that of leather and displays a Young's modulus (E) (measured in accordance with ISO 527) in the range of between 1 and 300 MPa, preferably in the range of between 20 and 100 MPa, in particular less than 70 MPa and flexural fatigue (measured in accordance with ISO5402) reaching greater than 100,000 cycles.

The novel aliphatic polyester compositions of this invention can be fabricated into commercially useful articles, such as, but not limited to multi-layer structures, fiber, monofilaments, thermoformed articles, blow-molded articles, injection molded articles, and injection stretch blow molding etc.

Optionally, additives may be added to the novel aliphatic polyester composition. Such additives may be mixed at a suitable time during the processing of the components for forming the aliphatic polyester material. One or more additives are included in the aliphatic polyester material to impart one or more selected functional characteristics to the aliphatic polyester material and any article made therefrom. Examples of additives that may be included in the present invention include, but are not limited to, heat stabilizers, process stabilizers, light stabilizers, antioxidants, slip/anti-block agents, pigments, UV absorbers, fillers, lubricants, pigments, dyes, colorants, flow promoters plasticizers, processing aids, branching agents, strengthening agents, nucleating agents (discussed in further detail below), talc, wax, calcium carbonate, radical scavengers, fire retardants, or a combination of one or more of the foregoing functional additives.

A fabricated article of manufacture having a net negative carbon value may comprise polyhydroxyalkanoate (PHA) wherein the PHA is PHB, PHBV, PHHx, or any other PHA, an ethylene-vinyl acetate copolymer resin (EVA) or similarly functional material, and an ester of citrate acid plasticizer or similarly functional material, wherein the PHA has a carbon negative value.

Additional embodiments and features are set forth in the description that follows, and in part will become apparent to those skilled in the art upon examination of the specification or may be learned by the practice of the disclosed embodiments. The features and advantages of the disclosed embodiments may be realized and attained by means of the instrumentalities, combinations, and methods described in the specification.

### BRIEF DESCRIPTION OF THE DRAWINGS

A further understanding of the nature and advantages of the disclosed embodiments may be realized by reference to the remaining portions of the specification and the drawings.

FIG. 1 is a Young's modulus bar graph comparing the novel aliphatic polyester composition without treatment and post treatment as described by the present invention.

FIG. 2 is a flex fatigue bar graph comparing the novel aliphatic polyester composition without treatment and post treatment as described by the present invention.

FIG. 3 is a graph demonstrating the percentage of shrink at varying temperatures of the novel aliphatic polyester composition post treatment as described by the present invention

In the appended figures, similar components and/or features may have the same reference label. Further, various components of the same type may be distinguished by following the reference label by a dash and a second label that distinguishes among the similar components. If only the first reference label is listed in the specification, the description is applicable to anyone of the similar components having the same first reference label irrespective of the second reference label.

### DETAILED DESCRIPTION OF THE INVENTION

The present specification generally relates an aliphatic polyester composition and a process for converting said aliphatic polyester composition into a textile that is preferable for use as an artificial leather substrate. The present invention discloses: (i) a novel aliphatic polyester composition comprising a polyhydroxyalkanoate (referred to herein as PHA), an ethylene-vinyl acetate copolymer resin (referred to herein as EVA), and an ester of citrate acid plasticizer; and (ii) an inventive process for converting the novel aliphatic polyester composition into a textile by (a) melt extruding the aliphatic polyester material into an aliphatic polyester sheet; (b) heating said sheet; (c) mono-axially or biaxially orienting said sheet including in the machine direction followed by orientation in the transverse direction; and (d) heating the biaxially oriented sheet at a temperature above the Tg of both the polyhydroxyalkanoate and ethylene-vinyl acetate resin components but below the melting point of the polyhydroxyalkanoate component. The resultant textile obtains a suppleness that is similar to that of leather and displays a Young's modulus (E) (measured in accordance with ISO 527) in the range of between 1 and 300 MPa, preferably in the range of between 20 and 100 MPa, in particular less than 70 MPa and flexural fatigue (measured in accordance with ISO 5402) reaching greater than 100,000 cycles.

It is to be understood that throughout this specification when PHA is referred to it is contemplated that this term includes homopolymers, random co-polymers, impact co-polymers and blends thereof. As used herein, the terms “functional properties” and “functional characteristics” shall be given their ordinary meanings and shall also refer to the specification, features, qualities, traits, or attributes of a material, including of a PHA or other materials. The functional characteristics of a PHA include, but are not limited to molecular weight, polydispersity and/or polydispersity index, melt flow and/or melt index, monomer composition, co-polymer structure, melt index, non-PHA material concentration, purity, impact strength, density, specific viscosity, viscosity resistance, acid resistance, mechanical shear strength, flexular modulus, elongation at break, freeze-thaw stability, processing conditions tolerance, shelf-life/stability, hygroscopicity, and color. As used herein, the term “polydispersity index” (or PDI), shall be given its ordinary meaning and shall be considered a measure of the distribution of molecular mass of a given polymer sample (calculated as the weight average molecular weight divided by the number average molecular weight).

Polyhydroxyalkanoates are biological polyesters synthesized by a broad range of natural and genetically engineered microorganisms and microorganism enzymes as well as genetically engineered plant crops (Braunegg, et al., 1998, J. Biotechnology 65:127-161; Madison and Huisman, 1999, Microbiology and Molecular Biology Reviews, 63:21-53; Poirier, 2002, Progress in Lipid Research 41:131-155). These polymers are biodegradable thermoplastic materials, can be produced from renewable resources, and have the potential for use in a broad range of industrial applications (Williams & Peoples, CHEMTECH 26:38-44 (1996)). Useful microbial strains for producing PHAs, include Cupriavidus necator (formerly known as Wautersia eutropha, Alcaligenes eutrophus (renamed as Ralstonia eutropha)), Alcaligenes latus, Aeromonas, Comamonas, Bacillus megaterium, Bacillus cereus SPV, Sinorhizobium meliloti, Azotobacter spp, Pseudomonas, and Methylosinus, spp Metylobacterium spp, and Methylococcus spp and genetically engineered organisms of the above mentioned microbes.

In general, a PHA is formed by enzymatic polymerization of one or more monomer units. Over 100 different types of monomers have been incorporated into the PHA polymers (Steinbuchel and Valentin, FEMS Microbiol. Lett., 128:219-228 (1995). Examples of monomer units incorporated in PHAs include 2-hydroxybutyrate, lactic acid, glycolic acid, 3-hydroxybutyrate (hereinafter referred to as 3HB), 3-hydroxypropionate (hereinafter referred to as 3HP), 3-hydroxyvalerate (hereinafter referred to as 3HV), 3-hydroxyhexanoate (hereinafter referred to as 3HH), 3-hydroxyheptanoate (hereinafter referred to as 3HHep), 3-hydroxyoctanoate (hereinafter referred to as 3HO), 3-hydroxynonanoate (hereinafter referred to as 3HN), 3-hydroxydecanoate (hereinafter referred to as 3HD), 3-hydroxydodecanoate (hereinafter referred to as 3HDd), 4-hydroxybutyrate (hereinafter referred to as 4HB), 4-hydroxyvalerate (hereinafter referred to as 4HV), 5-hydroxyvalerate (hereinafter referred to as 5HV), and 6-hydroxyhexanoate (hereinafter referred to as 6HH). 3-hydroxyacid monomers incorporated into PHAs are the (D) or (R) 3-hydroxyacid isomer with the exception of 3HP which does not have a chiral center.

The terms “PHA”, “PHAs”, and “polyhydroxyalkanoate”, as used herein, shall be given their ordinary meaning and shall include, but not be limited to, polymers generated by microorganisms or microorganism enzymes; biodegradable and/or biocompatible polymers that can be used as alternatives to petrochemical-based plastics such as polypropylene, polyethylene, and polystyrene; polymers produced by bacterial fermentation of sugars, lipids, or gases; thermoplastic or elastomeric materials derived from microorganisms or microorganism-derived enzymes; and/or polymers generated by chemical reaction not inside of microbial cell walls. PHAs include, but are not limited to, polyhydroxybutyrate (PHB), polyhydroxyvalerate (PHV), polyhydroxybutyrate-covalerate (PHBV), polyhydroxyhexanoate (PHHx) and blends thereof as discussed in detail below, as well as both short chain length (SCL), medium chain length (MCL), and long chain length (LCL) PHAs.

In some embodiments, the PHA is a homopolymer (all monomer units are the same). Examples of PHA homopolymers include poly 3-hydroxyalkanoates (e.g., poly 3-hydroxypropionate (hereinafter referred to as P3HP), poly 3-hydroxybutyrate (hereinafter referred to as PHB) and poly 3-hydroxyvalerate), poly 4-hydroxyalkanoates (e.g., poly 4-hydroxybutyrate (hereinafter referred to as P4HB), or poly 4-hydroxyvalerate (hereinafter referred to as P4HV)) and poly 5-hydroxyalkanoates (e.g., poly 5-hydroxyvalerate (hereinafter referred to as P5HV)).

In certain embodiments, the starting PHA is a copolymer (containing two or more different monomer units) in which the different monomers are randomly distributed in the polymer chain. Examples of PHA copolymers include poly 3-hydroxybutyrate-co-3-hydroxypropionate (hereinafter referred to as PHB3HP), poly 3-hydroxybutyrate-co-4-hydroxybutyrate (hereinafter referred to as PHB4HB), poly 3-hydroxybutyrate-co-4-hydroxyvalerate (hereinafter referred to as PHB4HV), poly 3-hydroxybutyrate-co-3-hydroxyvalerate (hereinafter referred to as PHB3HV), poly 3-hydroxybutyrate-co-3-hydroxyhexanoate (hereinafter referred to as PHB3HH), poly 3-hydroxybutyrate-co-3-hydroxyvalerate-co-3-hydroxyhexanoate (hereinafter referred to as PHB3HV3HH), poly 3-hydroxybutyrate-co-4-hydroxyvalerate (hereinafter referred to as PHB4HV) and poly 3-hydroxybutyrate-co-5-hydroxyvalerate (hereinafter referred to as PHB5HV).

By selecting the monomer types and controlling the ratios of the monomer units in a given PHA copolymer a wide range of material properties can be achieved. Although examples of PHA copolymers having two different monomer units have been provided, the PHA can have more than two different monomer units (e.g., three different monomer units, four different monomer units, five different monomer units, six different monomer units). An example of a PHA having 4 different monomer units would be PHB-co-3HH-co-3HO-co-3HD or PHB-co-3-HO-co-3HD-co-3HDd (these types of PHA copolymers are hereinafter referred to as PHB3HX). Typically where the PHB3HX has 3 or more monomer units the 3HB monomer is at least 70% by weight of the total monomers, preferably 85% by weight of the total monomers, most preferably greater than 90% by weight of the total monomers for example 92%, 93%, 94%, 95%, 96% by weight of the copolymer and the HX comprises one or more monomers selected from 3HH, 3HO, 3HD, 3HDd.

The homopolymer (where all monomer units are identical) PHB and 3-hydroxybutyrate copolymers (PHB3HP, PHB4HB, PHB3HV, PHB4HV, PHB5HV, PHB3HHP, hereinafter referred to as PHB copolymers) containing 3-hydroxybutyrate and at least one other monomer are of particular interest for commercial production and applications. It is useful to describe these copolymers by reference to their material properties as follows. Type 1 PHB copolymers typically have a glass transition temperature (Tg) in the range of 6° C. to −10° C., and a melting temperature (TM) of between 80° C. to 180° C. Type 2 PHB copolymers typically have a Tg of −20° C. to −50° C. and TM of 55° C. to 90° C. and are based on PHB4HB, PHB5HV polymers with more than 15% 4HB, SHV, 6HH content or blends thereof. In particular embodiments, the Type 2 copolymer have a phase component with a Tg of −15° C. to −45° C. and no TM.

As used in the present invention, the molecular weight of PHA ranges between about 5,000,000 and about 2,500,000 Daltons, between about 2,500,000 and about 1,000,000 Daltons, between about 1,000,000 and about 750,000 Daltons, between about 750,000 and about 500,000 Daltons, between about 500,000 and about 250,000 Daltons, between about 250,000 and about 100,000 Daltons, between about 100,000 and about 50,000 Daltons, between about 50,000 and about 10,000 Daltons, and overlapping ranges thereof.

In determining the molecular weight, techniques such as gel permeation chromatography (GPC) can be used. In the methodology, a polystyrene standard is utilized. The PHA can have a polystyrene equivalent weight average molecular weight (in Daltons) of at least 500, at least 10,000, or at least 50,000 and/or less than 2,000,000, less than 1,000,000, less than 1,500,000, and less than 800,000. In certain embodiments, preferably, the PHAs generally have a weight-average molecular weight in the range of 100,000 to 700,000. For example, the molecular weight range for PHB and Type 1 PHB copolymers for use in this application are in the range of 200,000 Daltons to 1.5 million Daltons as determined by GPC method and the molecular weight range for Type 2 PHB copolymers for use in the application 20,000 to 1.5 million Daltons.

In certain embodiments, the branched PHA, as discussed in further detail below, can have a linear equivalent weight average molecular weight of from about 150,000 Daltons to about 500,000 Daltons and a polydispersity index of from about 1.0 to about 8.0. As used herein, weight average molecular weight and linear equivalent weight average molecular weight are determined by gel permeation chromatography, using, e.g., chloroform as both the eluent and diluent for the PHA samples. Calibration curves for determining molecular weights are generated using linear polystyrenes as molecular weight standards and a “log MW vs. elution volume” calibration method.

PHAs for use in the methods and compositions described in this invention are selected from PHB; a PHA blend of PHB with a Type 1 PHB copolymer where the PHB content by weight of PHA in the PHA blend is in the range of 5% to 95% by weight of the PHA in the PHA blend; a PHA blend of PHB with a Type 2 PHB copolymer where the PHB content by weight of the PHA in the PHA blend is in the range of 5% to 95% by weight of the PHA in the PHA blend; a PHA blend of a Type 1 PHB copolymer with a different Type 1 PHB copolymer and where the content of the first Type 1 PHB copolymer is in the range of 5% to 95% by weight of the PHA in the PHA blend; a PHA blend of a Type 1 PHB copolymer with a Type 2 PHA copolymer where the content of the Type 1 PHB copolymer is in the range of 30% to 95% by weight of the PHA in the PHA blend; a PHA blend of PHB with a Type 1 PHB copolymer and a Type 2 PHB copolymer where the PHB content is in the range of 10% to 90% by weight of the PHA in the PHA blend, where the Type 1 PHB copolymer content is in the range of 5% to 90% by weight of the PHA in the PHA blend and where the Type 2 PHB copolymer content is in the range of 5% to 90% by weight of the PHA in the PHA blend.

The ethylene-vinyl acetate copolymer resin (EVA) used in the present invention has a vinyl acetate content suitable for the desired properties of the final material, including ductility and compatibility. In one embodiment, it has a vinyl acetate content of 65% to 95% by weight, more preferably 70% to 90%. In one embodiment, it has a vinyl acetate content of 35% to 65% by weight, more preferably 40% to 60%. In one embodiment, it has a vinyl acetate content of 5% to 95% by weight, more preferably 50%. In one embodiment, it has a vinyl acetate content of 5% to 35% by weight, more preferably 10% to 20%. In one embodiment, the vinyl acetate content is greater than 65% by weight to increase ductility. In one embodiment, the vinyl acetate content is less than 95% by weight to increase ductility.

Specific examples of the EVA include “Levapren 650HV” (EVA with a VA content of 65%) by weight manufactured by LANXESS, “Levapren 700HV” (EVA with a VA content of 70% by weight) manufactured by LANXESS, “Levapren 800HV” (EVA with a VA content of 80% by weight) manufactured by LANXESS, “Levapren 900HV” (EVA with a VA content of 90% by weight) manufactured by LANXESS, “Levapren 700XL” (partially-crosslinked EVA with a VA content of 70% by weight) manufactured by LANXESS, “Levapren 800XL” (partially-crosslinked EVA with a VA content of 80% by weight) manufactured by LANXESS, “Levamelt 700” (EVA with a VA content of 70% by weight) manufactured by LANXESS, “Levamelt 800” (EVA with a VA content of 80% by weight) manufactured by LANXESS, and “Soarblen DH” (EVA with a VA content of 70% by weight) manufactured by The Nippon Synthetic Chemical Industry Co., Ltd. At least one of the above referenced examples can be used.

The ester of citrate acid plasticizers useful in the present invention are preferably bio-derived alkyl derivatives of these esters such as triethyl citrate, n-tributyl citrate (TBC), n-hexyl citrate, and acetylated derivatives of these esters such as acetyl citrate, acetyl triethyl citrate, acetyl n-tributyl citrate and acetyl n-trihexyl citrate. The plasticizer content preferably lies in the range of between 0.1% and 30% by weight and more preferred between 1% and 20% by weight in relation to 100 parts by weight of the total weight amount of the PHA and EVA contained.

To provide an aliphatic polyester resin composition that can be advantageously processed to function as a substitute for leather derived from the animal hides that nevertheless exhibits the mechanical properties specified above, the Applicant has found that when PHA is blended with EVA and an ester of citrate acid plasticizer, and processed accordingly a textile having a suppleness that is similar to that of leather and displaying a Young's modulus (E) (measured in accordance with ISO 527) in the range of between 1 and 300 MPa, preferably in the range of between 20 and 100 MPa, in particular less than 70 MPa and flexural fatigue (measured in accordance with ISO 5402) reaching greater than 100,000 cycles can be obtained.

### Additives

In certain embodiments, various additives are added to the aliphatic polyester resin composition. Such additives may be mixed at a suitable time during the mixing of the components for forming the composition. The one or more additives are included in the aliphatic polyester resin compositions to impart one or more selected characteristics to the aliphatic polyester resin composition and any article made therefrom. Examples of additives that may be included in the present invention include, but are not limited to, heat stabilizers, process stabilizers, light stabilizers, antioxidants, slip/anti-block agents, pigments, UV absorbers, fillers, lubricants, pigments, dyes, colorants, flow promoters plasticizers, nucleating agents (discussed in further detail below), talc, wax, calcium carbonate, radical scavengers or a combination of one or more of the foregoing additives. Examples of suitable fillers include but are not limited to glass fibers and minerals such as precipitated calcium carbonate, ground calcium carbonate, talc, wollastonite, alumina trihydrate, wood flour, ground walnut shells, coconut shells, and rice husk shells and the like.

Optionally, additives are included in the aliphatic polyester resin composition of the present invention at a concentration of about 0.05 to about 20% by weight of the total composition. For example, the range in certain embodiments is about 0.05 to about 5% of the total composition. The additive is any compound known to those of skill in the art to be useful in the production of thermoplastics. Exemplary additives include, e.g., plasticizers (e.g., to increase flexibility of a thermoplastic composition), antioxidants (e.g., to protect the thermoplastic composition from degradation by ozone or oxygen), ultraviolet stabilizers (e.g., to protect against weathering), lubricants (e.g., to reduce friction), pigments (e.g., to add color to the thermoplastic composition), flame retardants, fillers, reinforcing, mold release, and antistatic agents. It is well within the skilled practitioner's abilities to determine whether an additive should be included in the aliphatic polyester resin composition of the present invention and, if so, what additive and the amount that should be added to the composition.

The additive(s) can also be prepared as a masterbatch for example, by incorporating the additive(s) in a PHA or PHA blend and producing pellets of the resultant composition for addition to subsequent processing. In a masterbatch the concentration of the additive(s) is (are) higher than the final amount for the product to allow for proportionate mixing of the additive in the final compound or composition and/or enable additional benefits, such as increased mixing, increased branching, increased homogeneity, and increased processing times. In certain embodiments, the EVA may be masterbatched with a PHA prior to addition to the final compound. In certain other embodiments, the EVA may be masterbatched with a nucleating agent prior to addition to the compound. In certain embodiments, the plasticizer may be masterbatched with PHA prior to addition to the compound. In certain embodiments, the plasticizer may be masterbatched with EVA prior to addition to the compound. In certain embodiments, the plasticizer may be masterbatched with PHA and EVA prior to addition to the compound. In certain embodiments, a nucleating agent may be masterbatched with PHA prior to addition to the compound. In certain embodiments, a branching and/or cross-linking agent may be masterbatched with PHA, EVA, or a plasticizer prior to addition to the compound.

In certain embodiments, the aliphatic polyester resin composition and methods of the invention include one or more surfactants. Surfactants are generally used to de-dust, lubricate, reduce surface tension, and/or densify. Examples of surfactants include, but are not limited to mineral oil, castor oil, and soybean oil. One mineral oil surfactant is DRAKEOL® 34 surfactant, available from Penreco (Dickinson, Tex., USA). MAXSPERSE® W-6000 surfactant and W-3000 solid surfactants are available from Chemax Polymer Additives (Piedmont, S.C., USA). Non-ionic surfactants with HLB values ranging from about 2 to about 16 can be used, examples being TWEEN-20 surfactant, TWEEN-65 surfactant, Span-40 surfactant and Span 85 surfactant.

Anionic surfactants include: aliphatic carboxylic acids such as lauric acid, myristic acid, palmitic acid, stearic acid, and oleic acid; fatty acid soaps such as sodium salts or potassium salts of the above aliphatic carboxylic acids; N-acyl-N-methylglycine salts, N-acyl-N-methyl-beta-alanine salts, N-acylglutamic acid salts, polyoxyethylene alkyl ether carboxylic acid salts, acylated peptides, alkylbenzenesulfonic acid salts, alkylnaphthalenesulfonic acid salts, naphthalenesulfonic acid salt-formalin polycondensation products, melaminesulfonic acid salt-formalin polycondensation products, dialkylsulfosuccinic acid ester salts, alkyl sulfosuccinate disalts, polyoxyethylene alkylsulfosuccinic acid disalts, alkylsulfoacetic acid salts, (alpha-olefinsulfonic acid salts, N-acylmethyltaurine salts, sodium dimethyl 5-sulfoisophthalate, sulfated oil, higher alcohol sulfuric acid ester salts, polyoxyethylene alkyl ether sulfuric acid salts, secondary higher alcohol ethoxysulfates, polyoxyethylene alkyl phenyl ether sulfuric acid salts, monoglysulfate, sulfuric acid ester salts of fatty acid alkylolamides, polyoxyethylene alkyl ether phosphoric acid salts, polyoxyethylene alkyl phenyl ether phosphoric acid salts, alkyl phosphoric acid salts, sodium alkylamine oxide bistridecylsulfosuccinates, sodium dioctylsulfosuccinate, sodium dihexylsulfosuccinate, sodium dicyclohexylsulfosuccinate, sodium diamylsulfosuccinate, sodium diisobutylsulfosuccinate, alkylamine guanidine polyoxyethanol, disodium sulfosuccinate ethoxylated alcohol half esters, disodium sulfosuccinate ethoxylated nonylphenol half esters, disodium isodecylsulfosuccinate, disodium N-octadecylsulfosuccinamide, tetrasodium N-(1,2-dicarboxyethyl)-N-octadecylsulfosuccinamide, disodium mono- or didodecyldiphenyl oxide disulfonates, sodium diisopropylnaphthalenesulfonate, and neutralized condensed products from sodium naphthalenesulfonate.

One or more lubricants can also be added to the compositions and methods of the invention. Lubricants are normally used to reduce sticking to hot metal surfaces during processing and can include polyethylene, paraffin oils, and paraffin waxes in combination with metal stearates (e.g., zinc sterate). Other lubricants include stearic acid, amide waxes, ester waxes, metal carboxylates, and carboxylic acids. Lubricants are normally added to polymers in the range of about 0.1 percent to about 1 percent by weight, generally from about 0.7 percent to about 0.8 percent by weight of the compound. Solid lubricants is warmed and melted before or during processing of the blend.

One or more anti-microbial agents can also be added to the compositions and methods of the invention. An anti-microbial is a substance that kills or inhibits the growth of microorganisms such as bacteria, fungi, or protozoans, as well as destroying viruses. Antimicrobial drugs either kill microbes (microbicidal) or prevent the growth of microbes (microbistatic). A wide range of chemical and natural compounds are used as antimicrobials, including but not limited to: organic acids, essential oils, cations and elements (e.g., colloidal silver). Commercial examples include but are not limited to PolySept® Z microbial, UDA and AGION®.

PolySept® Z microbial (available from PolyChem Alloy) is an organic salt based, non-migratory antimicrobial. “UDA” is Urtica dioica agglutinin. AGION® antimicrobial is a silver compound. AMICAL® 48 silver is diiodomethyl p-tolyl sulfone.

### Branched Polyhydroxyalkanoates

The term “branched PHA” refers to a PHA with branching of the chain and/or cross-linking of two or more chains. Branching on side chains is also contemplated. Branching can be accomplished by various methods. The PHAs described previously can be branched by branching agents by free-radical-induced cross-linking of the polymer. In certain embodiments, the PHA is branched prior to combination in the method. In other embodiments, the PHA is reacted with peroxide, free-radicals, cross-linkers, or other branching agents in the methods of the invention. The branching increases the melt strength of the polymer. PHA can be branched in any of the ways described in U.S. Pat. Nos. 6,620,869, 7,208,535, 6,201,083, 6,156,852, 6,248,862, 6,201,083 and 6,096,810 all of which are incorporated herein by reference in their entirety.

The polymers of the invention can also be branched according to any of the methods disclosed in International Publication No. WO 2010/008447, titled “Methods For Branching PHA Using Thermolysis” or International Publication No. WO 2010/008445, titled “Branched PHA Compositions, Methods for Their Production, and Use in Applications,” both of which were published in English on Jan. 21, 2010, and designated the United States. These applications are incorporated by reference herein in their entirety.

### Branching Agents

In one embodiment, branching agents, also referred to as free radical initiators, for use in the compositions and methods described herein include organic peroxides. Branching agents are selected from any suitable initiator known in the art, such as peroxides, azo-dervatives (e.g., azo-nitriles), peresters, and peroxycarbonates. Suitable peroxides for use in the present invention include, but are not limited to, organic peroxides, for example dialkyl organic peroxides such as 2,5-dimethyl-2,5-di(t-butylperoxy) hexane, 2,5-bis(t-butylperoxy)-2,5-dimethylhexane (available from Akzo Nobel as TRIGANOX 101), 2,5-dimethyl-di(t-butylperoxy)hexyne-3, di-t-butyl peroxide, dicumyl peroxide, benzoyl peroxide, di-t-amyl peroxide, t-amylperoxy-2-ethylhexylcarbonate (TAEC), t-butyl cumyl peroxide, n-butyl-4,4-bis(t-butylperoxy)valerate, 1,1-di(t-butylperoxy)-3,3,5-trimethyl-cyclohexane, 1,1-bis(t-butylperoxy)-3,3,5-trimethylcyclohexane (CPK), 1,1-di(t-butylperoxy)cyclohexane, 1,1-di(t-amylperoxy)-cyclohexane, 2,2-di(t-butylperoxy)butane, ethyl-3,3-di(t-butylperoxy)butyrate, 2,2-di(t-amylperoxy)propane, ethyl-3,3-di(t-amylperoxy)butyrate, di-(tert-butylperoxyisopropyl)benzene (VulCup®), t-butylperoxy-acetate, t-amylperoxyacetate, t-butylperoxybenzoate, t-amylperoxybenzoate, di-t-butyldiperoxyphthalate, and the like. Combinations and mixtures of peroxides can also be used. Examples of free radical initiators include those mentioned herein, as well as those described in, e.g., Polymer Handbook, 3rd Ed., J. Brandrup & E. H. Immergut, John Wiley and Sons, 1989, Ch. 2. Irradiation (e.g., e-beam or gamma irradiation) can also be used to generate PHA branching.

In one embodiment, the efficiency of branching and crosslinking of the polymer(s) can also be enhanced by the dispersion of organic peroxides in a cross-linking agent, such as a polymerizable (i.e., reactive) plasticizers containing reactive functionality such as a reactive unsaturated double bond to increase branching and crosslinking efficiency.

### Cross-Linking Agents

In one embodiment, cross-linking agents, also referred to as co-agents, are used in the methods and compositions of the invention and are cross-linking agents comprising two or more reactive functional groups such as epoxides or double bonds. In one embodiment, cross-linking agents modify the properties of the polymer. These properties include, but are not limited to, melt strength or toughness. Suitable types of cross-linking agent are agents with two or more double bonds. In one embodiment, cross-linking agents with two or more double bond cross-link PHAs by after reacting at the double bonds. Examples of these include: diallyl phthalate, pentaerythritol tetraacrylate, trimethylolpropane triacrylate, pentaerythritol triacrylate, dipentaerythritol pentaacrylate, diethylene glycol dimethacrylate, bis(2-methacryloxyethyl)phosphate. Compounds with and without terminal epoxides may be preferentially used. Compounds with a relatively low and high number of end groups may be used. Compounds with higher numbers of end groups relative to their molecular weight (e.g., the Joncryl® resins are in the 3000-4000 g/mol range) may be used, and compounds with fewer end groups relative to their molecular weight (e.g., the Omnova products have molecular weights in the 100,000-800,000 g/mol range) may also be used, preferentially, according to desired end-characteristics.

Suitable types of cross-linking agents include an “epoxy functional compound” including compounds with two or more epoxide groups capable of increasing the melt strength of polyhydroxyalkanoate polymers by branching, e.g., end branching as described above. In one embodiment, an epoxy functional compound is used as the cross-linking agent in the disclosed methods, wherein a branching agent may also be used. One embodiment of the invention is a method of branching a starting PHA. One embodiment of the invention is a method of branching a starting PHA, comprising reacting a starting PHA with an epoxy functional compound. One embodiment of the invention is a method of branching a starting PHA, comprising reacting a starting PHA with an epoxy functional compound and then further blending this reacted PHA with a plasticizer. One embodiment of the invention is a method of branching a starting PHA, comprising reacting a starting PHA with an epoxy functional compound and then further blending this reacted PHA with a plasticizer and copolymer resin containing vinyl acetate. One embodiment of the invention is a method of branching a starting PHA, comprising reacting a starting PHA with an epoxy functional compound and then further blending this reacted PHA with a plasticizer and copolymer resin containing vinyl acetate or similarly functional materials. One embodiment of the invention is a method of branching a starting PHA, comprising reacting a starting PHA with an epoxy functional compound and then further blending this PHA with an ethylene vinyl acetate copolymer resin and an ester of citrate or similarly functional materials. One embodiment of the invention is a method of branching a starting PHA, comprising reacting a starting PHA with an epoxy functional compound and then further blending this reacted PHA with a plasticizer and copolymer resin containing vinyl acetate or similarly functional materials. Alternatively, the invention is a method of branching a starting polyhydroxyalkanoate polymer, comprising reacting a starting PHA, a branching agent and an epoxy functional compound and then further blending this PHA with an ethylene vinyl acetate copolymer resin and an ester of citrate. Alternatively, the invention is a method of branching a starting polyhydroxyalkanoate polymer, comprising reacting a starting PHA, and an epoxy functional compound in the absence of a branching agent and then further blending this PHA with an ethylene vinyl acetate copolymer resin and an ester of citrate. Such epoxy functional compounds can include epoxy-functional, styrene-acrylic polymers (such as, but not limited to, e.g., MP-40 (Kaneka)), acrylic and/or polyolefin copolymers and oligomers containing glycidyl groups incorporated as side chains (poly(ethylene-glycidyl methacrylate-co-methacrylate)), and epoxidized oils (such as, but not limited to, e.g., epoxidized soybean, olive, linseed, palm, peanut, coconut, seaweed, cod liver oils, or mixtures thereof, e.g., Merginat® ESBO (Hobum, Hamburg, Germany) and EDENOL® B 316 (Cognis, Dusseldorf, Germany)).

For example, reactive acrylics or functional acrylics cross-linking agents are used to increase the molecular weight of the polymer in the branched polymer compositions described herein. Such cross-linking agents are sold commercially. One such compound is MP-40 (Kaneka) and still another is Petra line from Honeywell, see for example, U.S. Pat. No. 5,723,730. Such polymers are often used in plastic recycling (e.g., in recycling of polyethylene terephthalate) to increase the molecular weight (or to mimic the increase of molecular weight) of the polymer being recycled.

E.I. du Pont de Nemours & Company sells multiple reactive compounds such as ethylene copolymers, such as acrylate copolymers, elastomeric terpolymers, and other copolymers. Omnova sells similar compounds under the trade names “SX64053,” “SX64055,” and “SX64056.” Other entities also supply such compounds commercially.

Specific polyfunctional polymeric compounds with reactive epoxy functional groups are the styrene-acrylic copolymers. These materials are based on oligomers with styrene and acrylate building blocks that have glycidyl groups incorporated as side chains. A high number of epoxy groups per oligomer chain are used, for example 5, greater than 10, or greater than 20. These polymeric materials generally have a molecular weight greater than 3000, specifically greater than 4000, and more specifically greater than 6000. Other types of polyfunctional polymer materials with multiple epoxy groups are acrylic and/or polyolefin copolymers and oligomers containing glycidyl groups incorporated as side chains. These materials can further comprise methacrylate units that are not glycidyl. An example of this type is poly(ethylene-glycidyl methacrylate-co-methacrylate).

Fatty acid esters or naturally occurring oils containing epoxy groups (epoxidized) can also be used. Examples of naturally occurring oils are olive oil, linseed oil, soybean oil, palm oil, peanut oil, coconut oil, seaweed oil, cod liver oil, or a mixture of these compounds. Particular preference is given to epoxidized soybean oil (e.g., Merginat® ESBO from Hobum, Hamburg, or EDENOL® B 316 from Cognis, Dusseldorf), but others may also be used.

### Nucleating Agents

An optional nucleating agent is added to the aliphatic polyester resin composition to aid in its crystallization. Nucleating agents for various polymers are simple substances, metal compounds including composite oxides, for example, carbon black, calcium carbonate, synthesized silicic acid and salts, silica, zinc white, clay, kaolin, basic magnesium carbonate, mica, talc, quartz powder, diatomite, dolomite powder, titanium oxide, zinc oxide, antimony oxide, barium sulfate, calcium sulfate, alumina, calcium silicate, metal salts of organophosphates, and boron nitride; low-molecular organic compounds having a metal carboxylate group, for example, metal salts of such as octylic acid, toluic acid, heptanoic acid, pelargonic acid, lauric acid, myristic acid, palmitic acid, stearic acid, behenic acid, cerotic acid, montanic acid, melissic acid, benzoic acid, p-tert-butylbenzoic acid, terephthalic acid, terephthalic acid monomethyl ester, isophthalic acid, and isophthalic acid monomethyl ester; high-molecular organic compounds having a metal carboxylate group, for example, metal salts of such as: carboxyl-group-containing polyethylene obtained by oxidation of polyethylene; carboxyl-group-containing polypropylene obtained by oxidation of polypropylene; copolymers of olefins, such as ethylene, propylene and butene-1, with acrylic or methacrylic acid; copolymers of styrene with acrylic or methacrylic acid; copolymers of olefins with maleic anhydride; and copolymers of styrene with maleic anhydride; high-molecular organic compounds, for example: alpha-olefins branched at their 3-position carbon atom and having no fewer than 5 carbon atoms, such as 3,3 dimethylbutene-1,3-methylbutene-1,3-methylpentene-1,3-methylhexene-1, and 3,5,5-trimethylhexene-1; polymers of vinylcycloalkanes such as vinylcyclopentane, vinylcyclohexane, and vinylnorbornane; polyalkylene glycols such as polyethylene glycol and polypropylene glycol; poly(glycolic acid); cellulose; cellulose esters; and cellulose ethers; cyanuric acid; phosphoric or phosphorous acid and its metal salts, such as diphenyl phosphate, diphenyl phosphite, metal salts of bis(4-tert-butylphenyl) phosphate, and methylene bis-(2,4-tert-butylphenyl)phosphate; sorbitol derivatives such as bis(p-methylbenzylidene)sorbitol and bis(p-ethylbenzylidene)sorbitol; and thioglycolic anhydride, p-toluenesulfonic acid and its metal salts. The above nucleating agents may be used either alone or in combinations with each other. In certain embodiments, the nucleating agent can also be another polymer (e.g., polymeric nucleating agents such as PHB).

In various embodiments, where the nucleating agent is dispersed in a liquid carrier, the liquid carrier is a plasticizer, e.g., a citric compound or an adipic compound, e.g., acetylcitrate tributyrate ((CITROFLEX® A4) plasticizer, Vertellus, Inc., High Point, N.C.), or DBEEA (dibutoxyethoxyethyl adipate), a surfactant, e.g., Triton X-100 surfactant, TWEEN-20 surfactant, TWEEN-65 surfactant, Span-40 surfactant or Span 85 surfactant, a lubricant, a volatile liquid, e.g., chloroform, heptane, or pentane, an organic liquid or water.

In other embodiments, the nucleating agent is aluminum hydroxy diphosphate or a compound comprising a nitrogen-containing heteroaromatic core. The nitrogen-containing heteroaromatic core is pyridine, pyrimidine, pyrazine, pyridazine, triazine, or imidazole.

In particular embodiments, the nucleating agent can include aluminum hydroxy diphosphate or a compound comprising a nitrogen-containing heteroaromatic core. The nitrogen-containing heteroaromatic core is pyridine, pyrimidine, pyrazine, pyridazine, triazine, or imidazole.

The nucleating agent can be a nucleating agent as described in U.S. Pat. App. Pub. 2005/0209377, and WO 2009/129499, which are herein incorporated by reference in its entirety.

Suitable heat stabilizers include, for example, organo phosphites such as triphenyl phosphite, tris-(2,6-dimethylphenyl)phosphite, tris-(mixed mono- and di-nonylphenyl)phosphite or the like; phosphonates such as dimethylbenzene phosphonate or the like, phosphates such as trimethyl phosphate, or the like, or combinations including at least one of the foregoing heat stabilizers. Heat stabilizers are generally used in amounts of from 0.01 to 0.5 parts by weight based on 100 parts by weight of the total composition, excluding any filler.

Suitable antioxidants include, for example, organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methyl ene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations including at least one of the foregoing antioxidants. Antioxidants are generally used in amounts of from 0.01 to 0.5 parts by weight, based on 100 parts by weight of the total composition, excluding any filler.

Suitable light stabilizers include, for example, benzotriazoles such as 2-(2-hydroxy-5-methyl phenyl)benzotriazole, 2-(2-hydroxy-5-tert-octylphenyl)-benzotriazole and 2-hydroxy-4-n-octoxy benzophenone or the like or combinations including at least one of the foregoing light stabilizers. Light stabilizers are generally used in amounts of from 0.1 to 1.0 parts by weight, based on 100 parts by weight of the total composition, excluding any filler.

Suitable antistatic agents include, for example, glycerol monostearate, sodium stearyl sulfonate, sodium dodecylbenzenesulfonate or the like, or combinations of the foregoing antistatic agents. In one embodiment, carbon fibers, carbon nanofibers, carbon nanotubes, carbon black, or any combination of the foregoing may be used in a polymeric resin containing chemical antistatic agents to render the composition electrostatically dissipative.

Suitable mold releasing agents include for example, metal stearate, stearyl stearate, pentaerythritol tetrastearate, beeswax, montan wax, paraffin wax, or the like, or combinations including at least one of the foregoing mold release agents. Mold releasing agents are generally used in amounts of from 0.1 to 1.0 parts by weight, based on 100 parts by weight of the total composition, excluding any filler.

Suitable UV absorbers include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB® 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4-phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3,3-diphenyl-acryloyl)oxy]methyl]propane (UVINUL® 3030); 2,2′-(1,4-phenylene)bis(4H-3,1-benzoxazin-4-one); 1,3-bis[(2-cyano-3,3-diphenylacryloyl)oxy]-2,2-bis[[(2-cyano-3,3-diphenyl-acryloyl)oxy]methyl]propane; nano-size inorganic materials such as titanium oxide, cerium oxide, and zinc oxide, all with particle size less than 100 nanometers; or the like, or combinations including at least one of the foregoing UV absorbers. UV absorbers are generally used in amounts of from 0.01 to 3.0 parts by weight, based on 100 parts by weight based on 100 parts by weight of the total composition, excluding any filler.

Suitable pigments include for example, inorganic pigments such as metal oxides and mixed metal oxides such as zinc oxide, titanium dioxides, iron oxides or the like; sulfides such as zinc sulfides, or the like; aluminates; sodium sulfo-silicates; sulfates and chromates; carbon blacks; zinc ferrites; ultramarine blue; Pigment Brown 24; Pigment Red 101; Pigment Yellow 119; organic pigments such as azos, di-azos, quinacridones, perylenes, naphthalene tetracarboxylic acids, flavanthrones, isoindolinones, tetrachloroisoindolinones, anthraquinones, anthanthrones, dioxazines, phthalocyanines, and azo lakes; Pigment Blue 60, Pigment Red 122, Pigment Red 149, Pigment Red 177, Pigment Red 179, Pigment Red 202, Pigment Violet 29, Pigment Blue 15, Pigment Green 7, Pigment Yellow 147 and Pigment Yellow 150, or combinations including at least one of the foregoing pigments. Pigments are generally used in amounts of from 1 to 10 parts by weight, based on 100 parts by weight based on 100 parts by weight of the total composition, excluding any filler.

Suitable dyes include, for example, organic dyes such as coumarin 460 (blue), coumarin 6 (green), nile red or the like; lanthanide complexes; hydrocarbon and substituted hydrocarbon dyes; polycyclic aromatic hydrocarbons; scintillation dyes (preferably oxazoles and oxadiazoles); aryl- or heteroaryl-substituted poly(2-8 olefins); carbocyanine dyes; phthalocyanine dyes and pigments; oxazine dyes; carbon black; activated carbon; carbostyryl dyes; porphyrin dyes; acridine dyes; anthraquinone dyes; arylmethane dyes; azo dyes; diazonium dyes; nitro dyes; quinone imine dyes; tetrazolium dyes; thiazole dyes; perylene dyes, perinone dyes; bis-benzoxazolylthiophene (BBOT); and xanthene dyes; fluorophores such as anti-stokes shift dyes which absorb in the near infrared wavelength and emit in the visible wavelength, or the like; luminescent dyes such as 5-amino-9-diethyliminobenzo(a)phenoxazonium perchlorate; 7-amino-4-methylcarbostyryl; 7-amino-4-methylcoumarin; 3-(2′-b enzimidazolyl)-7-N,N-di ethylaminocoumarin; 3-(2′-benzothiazolyl)-7-diethylaminocoumarin; 2-(4-biphenyl)-5-(4-t-butylphenyl)-1,3,4-oxadiazole; 2-(4-biphenyl)-6-phenylb enzoxazole-1,3; 2,5-Bis-(4-biphenyl)-1)-1,3,4-oxadiazole; 2,5-bis-(4-biphenyl)-oxazole; 4,4′-bis-(2-butyloctyloxy)-p-quaterphenyl; p-bis(o-methylstyryl)-benzene; 5,9-diaminobenzo(a)phenoxazonium perchlorate; 4-dicy anom ethyl ene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-diethylamino-4-methylcoumarin; 7-diethylamino-4-trifluoromethylcoumarin; 2,2′-dimethyl-p-quaterphenyl; 2,2-dimethyl-p-terphenyl; 7-ethylamino-6-methyl-4-trifluorom ethyl coumarin; 7-ethyl amino-4-trifluorom ethyl coumarin; nile red; rhodamine 700; oxazine 750; rhodamine 800; IR 125; IR 144; IR 140; IR 132; IR 26; IRS; diphenylhexatriene; diphenylbutadiene; tetraphenylbutadiene; naphthalene; anthracene; 9,10-diphenylanthracene; pyrene; chrysene; rubrene; coronene; phenanthrene or the like, or combinations including at least one of the foregoing dyes. Dyes are generally used in amounts of from 0.1 to 5 parts by weight, based on 100 parts by weight of the total composition, excluding any filler.

Suitable colorants include, for example titanium dioxide, anthraquinones, perylenes, perinones, indanthrones, quinacridones, xanthenes, oxazines, oxazolines, thioxanthenes, indigoids, thioindigoids, naphthalimides, cyanines, xanthenes, methines, lactones, coumarins, bis-benzoxazolylthiophene (BBOT), naphthalenetetracarboxylic derivatives, monoazo and diazo pigments, triarylmethanes, aminoketones, bis(styryl)biphenyl derivatives, and the like, as well as combinations including at least one of the foregoing colorants. Colorants are generally used in amounts of from 0.1 to 5 parts by weight, based on 100 parts by weight of the total composition, excluding any filler.

Suitable blowing agents include for example, low boiling halohydrocarbons and those that generate carbon dioxide; blowing agents that are solid at room temperature and when heated to temperatures higher than their decomposition temperature, generate gases such as nitrogen, carbon dioxide, ammonia gas, such as azodicarbonamide, metal salts of azodicarbonamide, 4,4′ oxybis(benzenesulfonylhydrazide), sodium bicarbonate, ammonium carbonate, or the like, or combinations including at least one of the foregoing blowing agents. Blowing agents are generally used in amounts of from 1 to 20 parts by weight, based on 100 parts by weight of the total composition, excluding any filler.

Additionally, materials to improve flow and other properties may be added to the composition, such as low molecular weight hydrocarbon resins. Particularly useful classes of low molecular weight hydrocarbon resins are those derived from petroleum C5 to C9 feedstock that are derived from unsaturated C5 to C9 monomers obtained from petroleum cracking. Non-limiting examples include olefins, e.g. pentenes, hexenes, heptenes and the like; diolefins, e.g. pentadienes, hexadienes and the like; cyclic olefins and diolefins, e.g. cyclopentene, cyclopentadiene, cyclohexene, cyclohexadiene, methyl cyclopentadiene and the like; cyclic diolefin dienes, e.g., dicyclopentadiene, methylcyclopentadiene dimer and the like; and aromatic hydrocarbons, e.g. vinyltoluenes, indenes, methylindenes and the like. The resins can additionally be partially or fully hydrogenated.

### Application of the Aliphatic Polyester Resin Composition

Provided herein is a method of forming a monoaxially or biaxially oriented aliphatic polyester resin composition. The method includes mixing: PHA, EVA and an ester of citrate acid, or similarly functional and jointly compatible materials, under conditions sufficient to form a largely homogeneous composition; thereby forming an aliphatic polyester resin composition that is capable of forming films or sheets having the desired physical and mechanical properties, including wherein the Tg of the PHA and EVA are combined into one Tg peak. The thickness of the sheet is preferably in the range of between 0.1 and 3.2 mm, preferably in the range of between 0.2 and 2 mm, in particular less than 2 mm.

In one embodiment, a method is provided for improving the functional characteristics of melt extruded aliphatic polyester resin sheet comprising PHA, EVA and an ester of citrate acid, comprising the steps of: (a) annealing of the sheet pre-biaxial orientation at 50-170, 40-175, 60-160, 70-150, and 80-140° C. for 5-600 minutes allowing for more uniform and consistent stretching; (b) orientating the annealed sheet in the machine direction followed by orientation in the transverse direction leading to a shish-kebab crystal orientation and less chain orientation in the machine direction creating less anisotropy in the transverse direction, orientating the annealed sheet in the transverse direction followed by orientation in the machine direction leading to a shish-kebab crystal orientation and less chain orientation in the machine and/or transverse direction creating less anisotropy in the machine and/or transverse direction, orientating the annealed sheet in the transverse direction, or orientating the annealed sheet in the machine direction; (c) annealing of monoaxially or biaxially oriented sheet during orientation including heating the monoaxially biaxially oriented sheet above the Tg temperature of both the polyhydroxyalkanoate and ethylene vinyl acetate resin but below the melting point of the polyhydroxyalkanoate component, thereby allowing for relaxation of polymer chains into oriented conformation.

In certain embodiments, the aliphatic polyester resin composition is made by melt mixing the individual components to produce a homogeneous mixture. The mixture is then used for conversion into fabricated parts through sheet or melt extrusion, fiber extrusion, cast film extrusion, and blown film extrusion. For film applications the composition of the invention may be the complete film or one or more layers in a multilayer co-extruder composite structure. Alternatively, the aliphatic polyester resin composition may form different layers within a coextruded laminate, where each layer has a slightly different composition.

Additionally, provided herein is a method for forming an aliphatic polyester resin pellet, where the method includes combining: the PHA, EVA and an ester of citrate acid components or similarly functional materials, where the composition is melted and formed under suitable conditions to form a resin pellet which are subsequently processible into blown and cast free-standing films.

In any of the compositions, methods, processes or articles described herein, the PHA, EVA, and an ester of citrate acid components can be in the form of a fine particle size powder, pellet, or granule and combined by mixing or blending, and can be substituted with similarly functional materials.

### Sheet Production

In a further embodiment of the present invention there is provided a method for producing sheets of material comprising PHA. The method involves melt processing the aliphatic polyester resin composition of the present invention, preferably in the form of the PHA, forming the melt into a sheet, for example by blowing a bubble through a circular die or by casting on cooling rolls through a die, such as but not limited to a coat hanger die, or a T shape flat die, subjecting the sheet to a temperature above room temperature to induce a degree of polymer chain relaxation or annealing; followed by orientation of the sheet by step-wise or continuous monoaxial or biaxial stretching. The compositions described herein are processed preferably at a temperature above the Tg of both the polyhydroxyalkanoate and ethylene-vinyl acetate resin components but below the melting point of the polyhydroxyalkanoate component. While in heat plasticized condition, the aliphatic polyester resin composition is processed into a sheet. Such processing is performed using any art-known technique, such as, but not limited to, melt extrusion, blowing or blow molding (e.g., blown film, blowing of foam), calendaring. The Mw of the PHA in the film is greater than 50,000, 100,000, 250,000, 300,000, 400,000, 500,000, or 750,000 da, as determined by GPC. While nucleants are also typically used in the production of PHA films, as they tend to reduce spherulite size of PHA, the Applicant has surprisingly discovered that a particle size of greater than 5-20 micrometers inherently creates weak points throughout the sheet. Consequently, reduction of the nucleant size to particles that are less than 20, 10, and 5 micrometers have been found to increase various characteristics of the final product. The decrease in particle size has allowed for less nucleant required at the same efficiency due to the increased surface area. The decrease in both nucleant loading and particle size has allowed for a more reproducible increase in fatigue life of the textile of the present invention of this invention.

The PHA film compositions of the present invention are preferably oriented, either monoaxially or biaxially, in order to maximize mechanical properties. Biaxially oriented means to stretch the film along a direction in which it travels, called the machine direction, and in a direction 90° C. to the machine direction in the plane of the film, known as the transverse direction, thereby extending length and width of the film to greater than its initial dimensions. Biaxial orientation may involve simultaneous or sequential stretching. Monoaxial orientation refers to stretching in either the machine direction or the transverse direction, but not necessarily both. PHA film compositions of the present invention are formed into films of a uniform thickness ranging from about 20 to 150, 10 to 350, and 5 to 500 microns prior to orientation, and ranging from about 5 to 100, 2 to 200, and 1 to 300 microns, respectively, after orientation.

In one embodiment the sheet can be biaxially stretched according to a successive biaxial stretching method. In such method the film is first annealed at temperature in the range of 50-170° C., 50-180° C., 60-170° C., 60-180° C., 50-150° C., 100-165, or 125-165° C. In one embodiment after annealing the sheet is then stretched in the longitudinal direction (occasionally referred to as the machine direction, or “MD”) by a roll technique or any other suitable technique. This involves drawing the sheet by one or more downstream rollers rotating at faster rates than upstream rollers. The mono-directionally stretched film is then stretched laterally in the transverse direction (“TD” or cross direction) for example by a tenter method or any other suitable technique. The film can be heat set after TD stretching. In one embodiment, the film can be simultaneously biaxially stretched in the longitudinal and lateral directions simultaneously by conventional techniques. In another embodiment, annealing may be carried out before, after, or during each stretching step. In another embodiment, the material may be stretched in the TD prior to be stretched in the MD. In another embodiment, the material may be stretched in both the TD and MD in approximately the same time or at a defined rate relative to each other, including hold times at temperatures ranging from 40-175° C. at various intervals.

Longitudinal stretching and lateral stretching each is preferably about 1.5-16 times. To obtain desirable film strength and evenness of thickness, stretching is more preferably at least two, three, four, five, nine, twelve, or sixteen times each longitudinal and lateral direction. Preferably area stretching ratio which is obtained by multiplying the longitudinal and lateral stretching ratios is about 6.8-36 times.

For successive biaxial stretching, the longitudinal stretching temperature is preferably 50-1500° C. and the lateral stretching temperature is preferably 50-150° C. For simultaneous biaxial stretching, stretching is preferably carried out at 50-1500° C. If the area stretching magnification and the stretching temperatures are not within the above said ranges, the thickness of the film tends to be excessively variable.

It would be understood by one skilled in the art that the PHA film compositions of the present invention may include a number of additives or other components which are commonly included in polymeric films without departing from the spirit and scope of the present invention. These may include, for example, dyes, fillers, stabilizers, modifiers, anti-blocking additives, antistatic agents etc.

The PHA film compositions of the present invention are useful for numerous applications involving textiles. The films are particularly well suited for production of apparel, shoes, furniture, and automotive accessories.

In a further embodiment which overcomes many such limitations, there is provided a process for producing PHA films. Previously, a continuous process for the production of blown and cast free-standing PHA film has been difficult to develop due in part to poor melt strength of the material. The method involves melt processing PHA, preferably in the form of the PHA pellets of this invention, forming the melt into a film, for example by blowing a bubble through a circular die or by casting on cooling rolls through a T shape flat die, and orienting the film by continuous mono- or bi-axial stretching. While the Mw of the PHA in the film is largely dependent upon the Mw of the starting material, it is preferable for the Mw to be greater than 100,000, 200,000, 300,000, 400,000, or 500,000 daltons, depending on the final desired properties of the material, including especially 100,000 or 300,000 daltons. The Mw of the PHA in the pellets used to produce the sheet will depend whether PHA thermal stabilizers are present. If none are present, the PHA in the pellets preferably has a molecular weight greater than about 300,000. If PHA thermal stabilizers are present in accordance with the present invention, the Mw of the PHA in the pellets can be in the range of 50,000-250,000 while still being suitable for producing sheet containing PHA of the desired Mw greater than about 300,000.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute examples of preferred modes for its practice. However, those of skill in the art should, in light of the present disclosure, appreciate that many changes can be made in the specific embodiments which are disclosed and still obtain a like or similar result without departing from the spirit and scope of the invention.

Having disclosed several embodiments, it will be recognized by those of skill in the art that various modifications, alternative constructions, and equivalents may be used without departing from the spirit of the disclosed embodiments. Additionally, a number of well-known processes and elements have not been described in order to avoid unnecessarily obscuring the present invention. Accordingly, the above description should not be taken as limiting the scope of the invention.

### EXAMPLES

### Example 1

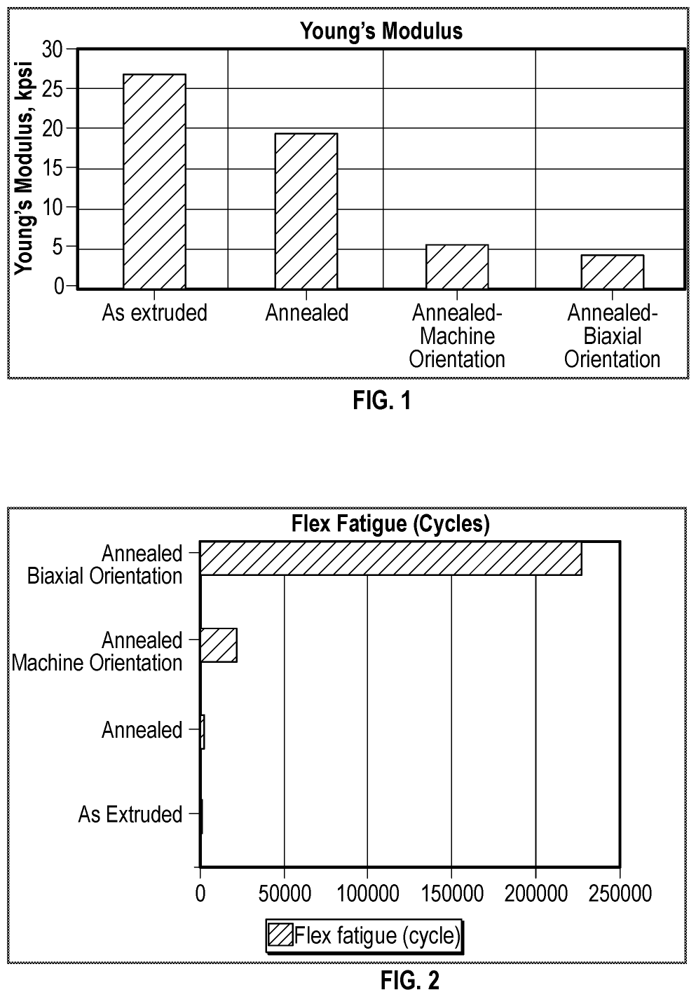

Poly-3-hydroxybutyrate homopolymer, ethylene vinyl-acetate with a vinyl acetate monomer content between 65 and 85% by weight, and acetyl tributyl citrate were premixed with a nucleating agent. The premix was then added to an extrusion melt blending machine to obtain the bio-based thermoplastic elastomeric material. The material is dried before being melt extruded into a cast film of thickness in the range of 0.1 mm to 1.5 mm and preferably 0.1 mm to 0.6 mm, and more preferably 0.5 mm to 0.8 mm. The film was subsequently annealed at a temperature in the range of about 120-165° C. The film was allowed to cool before orientation in the machine direction. The film was then stretched in the machine direction followed by the transverse direction, each direction reaching 1 to 10 times its original length. The film was then aged for 12 hours before tensile and elasticity testing took place. Tensile data, as shown in Table 1, below was collected per ASTM D638 and Young's modulus is graphically represented in FIG. 1.

TABLE 1

| | | | Annealed | Annealed |
|---|---|---|---|---|
| | | | 140° C.- | 140° C.- |
| | | Annealed | 20 min - | 20 min - |
| | As- | 140° C.- | machine | biaxial |
| Tensile Properties | extruded | 20 min | orientation | orientation |
| Break Stress | 2750 | 2514 | 3487 | 3906 |
| Break Strain | 415 | 272 | 294 | 280 |
| Yield Stress | 1600 | 1400 | — | — |
| Yield Strain | 15 | 13 | — | — |
| Young's Modulus | 27 | 19 | 5 | 4 |
| % Change in | 0 | 27 | 80 | 85 |
| modulus | | | | |

Flexural fatigue resistance was calculated on a Bally's flexometer per ASTM D4158, the data of which is found in Table 2 and represented in FIG. 2.

TABLE 2

| | Flex | |
|---|---|---|
| | fatigue | % |
| | (cycles) | Increase |
| As extruded | 1,300 | 0 |
| Annealed | 2,400 | 85 |
| Annealed- machine orientation | 20,275 | 1,460 |
| Annealed- biaxial orientation | 227,094 | 17,369 |

### Example 2

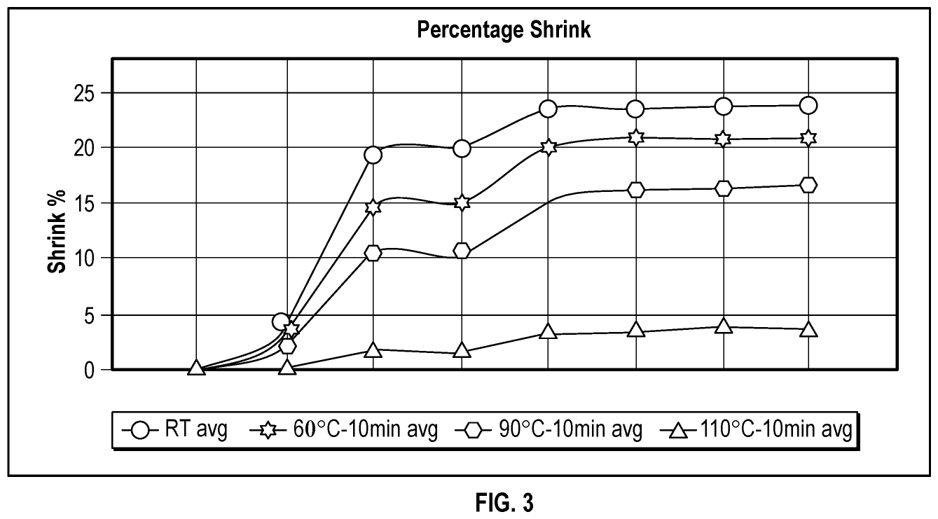

Poly-3-hydroxybutyrate homopolymer, ethylene vinyl-acetate with an acetate monomer content between 65 and 85% by weight, acetyl tributyl citrate, and a nucleating agent having a particle size of less than 5 micrometers were added to an extrusion melt blending machine to obtain a thermoplastic elastomeric material. This material was then melt extruded into a cast film of thickness in the range of 0.1 mm to 1.5 mm, and preferably 0.1 mm to 0.6 mm, and more preferably 0.5 mm to 0.8 mm. The film was subsequently annealed at a temperature above the Tg of both the polyhydroxyalkanoate and ethylene-vinyl acetate resin components but below the melting point of the polyhydroxyalkanoate component. The film was then stretched to 3 times its original length in the machine direction and given a heat soak under tension at a temperature again above the Tg of both the polyhydroxyalkanoate and ethylene-vinyl acetate resin components but below the melting point of the polyhydroxyalkanoate component. Measurements were taken at various time lengths and elevated temperatures for shrinkage data, see Table 3 and FIG. 3.

TABLE 3

| | Start | | Overnight RT | | 90° C. 1 min | | 90° C. 1 min | |
|---|---|---|---|---|---|---|---|---|
| | Length | % | Length | % | Length | % | Length | % |
| | (cm) | Shrink | (cm) | Shrink | (cm) | Shrink | (cm) | Shrink |
| RT avg | 16.00 | 0.00 | 15.35 | 3.94 | 12.90 | 19.14 | 12.75 | 20.06 |
| 60° C. - | 16.00 | 0.00 | 15.45 | 3.35 | 13.63 | 14.66 | 13.55 | 15.12 |
| 10 min avg | | | | | | | | |
| 90° C. - | 18.00 | 0.00 | 17.60 | 2.22 | 16.15 | 10.28 | 16.10 | 10.56 |
| 10 min avg | | | | | | | | |
| 110° C. - | 19.00 | 0.00 | 19.00 | 0.00 | 18.68 | 1.71 | 18.70 | 1.58 |
| 10 min avg | | | | | | | | |
| | 50° C. @ | | 50° C. @ | | | | 40° C. @ | |
| | 85 min | | 14 hours | | RT @ 72 hours | | 12 hours | |
| | Length | % | Length | % | Length | % | Length | % |
| | (cm) | Shrink | (cm) | Shrink | (cm) | Shrink | (cm) | Shrink |
| RT avg | 12.20 | 23.45 | 12.20 | 23.45 | 12.15 | 23.78 | 12.15 | 23.78 |
| 60° C. - | 12.75 | 20.14 | 12.65 | 20.76 | 12.65 | 20.76 | 12.65 | 20.76 |
| 10 min avg | | | | | | | | |
| 90° C. - | 15.30 | 15.00 | 15.13 | 15.97 | 15.05 | 16.39 | 15.05 | 16.39 |
| 10 min avg | | | | | | | | |
| 110° C. - | 18.40 | 3.16 | 18.35 | 3.42 | 18.30 | 3.68 | 18.30 | 3.68 |
| 10 min avg | | | | | | | | |

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the dielectric material” includes reference to one or more dielectric materials and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A monoaxially oriented, biaxially oriented, and/or annealed aliphatic polyester resin composition comprising a polyhydroxyalkanoate, an ethylene-vinyl acetate copolymer resin, and an ester of citrate acid plasticizer or similarly functional materials, wherein said polyhydroxyalkanoate and said ethylene vinyl acetate copolymer resin show a single Tg.

2. The monoaxially oriented, biaxially oriented, and/or annealed aliphatic polyester resin composition of claim 1, wherein the weight ratio of said polyhydroxyalkanoate to said ethylene-vinyl acetate copolymer is about 10% to about 90% by weight PHA, about 10% to about 90% by weight EVA and about 1% to about 25% by weight said ester of citrate acid plasticizer.

3. The monoaxially oriented, biaxially oriented, and/or annealed aliphatic polyester resin composition of claim 2, wherein the weight ratio of said polyhydroxyalkanoate to said ethylene-vinyl acetate copolymer is about 20% to about 80% by weight PHA, about 20% to about 80% by weight EVA and about 2% to about 20% by weight said ester of citrate acid plasticizer.

4. The monoaxially oriented, biaxially oriented, and/or annealed aliphatic polyester resin composition of claim 3, wherein the weight ratio of said polyhydroxyalkanoate to said ethylene-vinyl acetate copolymer is about 30% to about 70% by weight PHA, about 30% to about 70% by weight EVA and about 3% to about 20% by weight said ester of citrate acid plasticizer.

5. The monoaxially oriented, biaxially oriented, and/or annealed aliphatic polyester resin composition of claim 4, wherein the weight ratio of said polyhydroxyalkanoate to said ethylene-vinyl acetate copolymer 51% by weight PHA, 35% by weight EVA and 14% by weight said ester of citrate acid plasticizer.

6. The monoaxially oriented, biaxially oriented, and/or annealed aliphatic polyester resin composition of claim 5, wherein ester of citrate acid plasticizer is bio-derived.

7. The monoaxially oriented, biaxially oriented, and/or annealed aliphatic polyester resin composition of claim 1, wherein said polyhydroxyalkanoate has a molecular weight of about 100,000 to 1,000,000 da.

8. The monoaxially oriented, biaxially oriented, and/or annealed aliphatic polyester resin composition of claim 1, wherein said ethylene vinyl acetate copolymer resin contains a vinyl acetate content of 50 to 90% by weight.

9. The monoaxially oriented, biaxially oriented, and/or annealed aliphatic polyester resin composition of claim 1, wherein said polyhydroxyalkanoate is selected from the group consisting of poly (3-hydroxybutyrate), poly(3-hydroxybutyrate-co-3-hydroxyvalerate), poly(3-hydroxybutyrate-co-3-hydroxyvalerate-co-3-hydroxyhexanoate), poly(3-hydroxybutyrate-co-3-hydroxyhexanoate), and poly(3-hydroxybutyrate-co-4-hydroxybutyrate) or combinations thereof.

10. The monoaxially oriented, biaxially oriented, and/or annealed aliphatic polyester resin composition of claim 1, further comprising a branching agent and a co-agent, wherein the concentration of branching agent is between 0.005% to 1% by weight with respect to 100 parts by weight of the total amount of the composition.

11. The monoaxially oriented, biaxially oriented, and/or annealed aliphatic polyester resin composition of claim 10, wherein the weight ratio of said branching agent to said co-agent is 30 to 70% by weight.

12. The monoaxially oriented, biaxially oriented, and/or annealed aliphatic polyester resin composition of claim 1, further comprising a nucleant, wherein said nucleant has a particle size less than 5 micrometers.

13. A resin composition comprising: a polyhydroxyalkanoate resin, an ethylene-vinyl acetate copolymer resin (EVA), and an ester of citrate acid or similarly functional materials.

14. The resin composition of claim 1, wherein the weight ratio of said polyhydroxyalkanoate to said ethylene-vinyl acetate copolymer is about 10% to about 90% by weight PHA, about 10% to about 90% by weight EVA and about 1% to about 25% by weight said ester of citrate acid plasticizer or similarly functional materials.

15. The resin composition of claim 14, wherein the weight ratio of said polyhydroxyalkanoate to said ethylene-vinyl acetate copolymer is about 20% to about 80% by weight PHA, about 20% to about 80% by weight EVA and about 2% to about 20% by weight said ester of citrate acid plasticizer or similarly functional materials.

16. The resin composition of claim 15, wherein the weight ratio of said polyhydroxyalkanoate to said ethylene-vinyl acetate copolymer is about 30% to about 70% by weight PHA, about 30% to about 70% by weight EVA and about 3% to about 20% by weight said ester of citrate acid plasticizer or similarly functional materials.

17. The resin composition of claim 14, wherein said polyhydroxyalkanoate has a molecular weight of about 100,000 to 1,000,000 da.

18. A process for producing a monoaxially oriented, biaxially oriented, and/or annealed aliphatic polyester resin composition, comprising:
melt extruding an aliphatic polyester resin composition comprising a polyhydroxyalkanoate, an ethylene-vinyl acetate copolymer resin or similarly functional material, and an ester of citrate acid plasticizer or similarly functional material
annealing said melt extruded sheet at 50-170° C.;
orienting said annealed sheet in the machine direction followed by orientation in the transverse direction, in the transverse direction followed by orientation in the machine direction, in the machine direction, or in the transverse direction; and
annealing monoaxially or biaxially oriented sheet during orientation above Tg of both said polyhydroxyalkanoate and said ethylene vinyl acetate resin but below the melting point of said polyhydroxyalkanoate component.

19. The process of claim 18, wherein said aliphatic polyester resin composition allows for orientation of more than 50% in both machine and transverse direction.

20. The process of claim 18, wherein said monoaxial orientation, biaxial orientation, and/or annealing results in a shish-kebab crystal orientation and less chain orientation in the machine direction or transverse direction creating less anisotropy in the machine direction or transverse direction.

21. The process of claim 18, wherein said melt extruded sheet has thickness between 0.1 mm to 3.2 mm.

22. The process of claim 19, said melt extruded sheet is further monoaxially or biaxially orientated to yield a thermoplastic polymeric sheet with increased toughness, fatigue life, and flexibility.

23. The process of claim 19, wherein said melt extruded sheet has a thickness between 0.1 mm to 3.2 mm.

24. The process of claim 18, wherein said annealing said melt extruded sheet is maintained at 50-170° C. for 5-600 minutes.

25. A process for producing a monoaxially oriented, biaxially oriented, and/or annealed aliphatic polyester resin composition, comprising:
annealing a melt extruded aliphatic polyester resin sheet at 50-170° C. for 5-600 minutes wherein said melt extruded aliphatic polyester resin sheet comprises a polyhydroxyalkanoate, an ethylene-vinyl acetate copolymer resin or similarly functional material, and an ester of citrate acid plasticizer or similarly functional material at 50-170° C. for 5-600 minutes;
orienting said annealed sheet first in either the machine direction or the transverse direction and optionally second in either the machine direction or the transverse direction creating a monoaxially or biaxially oriented sheet; and
annealing said monoaxially or biaxially oriented sheet during orientation above Tg of both said polyhydroxyalkanoate and said ethylene vinyl acetate resin but below the melting point of said polyhydroxyalkanoate component.
